(19) United States
(12) Patent Application Publication
(10) Pub. No.: US 2026/0287738 A1
(43) Pub. Date: Sep. 24, 2026

(54) Sensor Fusion in a Vehicle of Sensors Having Different Cycle Times

(71) Applicant: Bayerische Motoren Werke Aktiengesellschaft, Muenchen (DE)

(72) Inventors: Stefan HOLZKNECHT, Feldkirchen (DE); Juan Carlos FUENTES MICHEL, Muenchen (DE)

(21) Appl. No.: 19/570,986

(22) Filed: Mar. 18, 2026

(30) Foreign Application Priority Data
Mar. 19, 2025 (DE) 10 2025 110 681.9

(51) Int. Cl. G01S 13/931; G01S 13/86

(52) U.S. Cl. CPC G01S 13/931; G01S 13/867; G01S 2013/93185

(57) ABSTRACT

A method for operating a motor vehicle sensor arrangement having a radar device and a further sensor device includes operating the radar device using a radar cycle and a set of emission signals within the radar cycle. After passage of a partial cycle of the radar cycle, partial information is processed. The partial information characterizes reception signals according to a subset of the set of emission signals corresponding to the partial cycle. After passage of the radar cycle, cycle information is processed. The cycle information characterizes reception signals according to the set of emission signals. The sensor device is operated using a sensor cycle. The radar cycle is shorter than the sensor cycle. After passage of the partial cycle, a close-range characterization is output on the basis of the partial information. At the end of the sensor cycle and/or a multiple of the sensor cycle, the cycle information is output.

### CROSS REFERENCE TO RELATED APPLICATION

This application claims priority under 35 U.S.C. §119 from German Patent Application No. 10 2025 110 681.9, filed Mar. 19, 2025, the entire disclosure of which is herein expressly incorporated by reference.

### BACKGROUND AND SUMMARY

The present disclosure relates to a method for operating a sensor arrangement of a motor vehicle, wherein the sensor arrangement comprises a radar device and a further sensor device. The disclosure also relates to a computer program and/or computer-readable medium, a data processing device, and a motor vehicle.

Such sensor arrangements and methods for operating a sensor arrangement are known from the prior art. For example, radar devices for motor vehicles typically have a fixed cycle time. Data are generated and processed within the cycle time. In other words, the radar device provides, for example, information about detected objects and/or distances after passage of the cycle time, for example via a vehicle bus. Within the cycle time, emission signals are generated, in the case of a continuous-wave radar ("frequency modulated continuous-wave radar", FMCW radar) also called chirps, and reflected reception signals are received, and subsequent data processing or raw data processing takes place. Processes can partially run in parallel in this case, wherein after the passage of the cycle time, the data are provided and the generation of emission signals begins again upon a beginning of a cycle time. For example, a typical cycle time in a motor vehicle can be 50 ms.

In addition to a radar device for acquiring distance information, such a sensor arrangement can comprise, for example, a camera as a further sensor device. A so-called data fusion or sensor fusion takes place so that sensor data of the sensor device and information of the radar device can be jointly evaluated or processed. The sensor data of the sensor device and the information of the radar device are merged in this case. Sensor fusion is known from the prior art and can be applied in general to a large number of sensors, for example a lidar device can take the place of a radar device.

EP 3 525 131 A1 relates to a concept for object recognition in a scene, which is represented by depth data of a distance recognition sensor and image data of a camera. The depth data are projected onto the image data to generate projected depth data. The projected depth data are coded in multichannel information in order to generate coded projected depth data. Hybrid data, which consist of the image data and the coded projected depth, are fed into one or more convolutional neural networks, which are configured so that they recognize or classify objects in the scene based on the image data and the coded projected depth data.

EP 3 438 776 A1 relates to a method. The method comprises receiving camera sensor data from a camera of the vehicle. The method comprises receiving lidar sensor data from a lidar sensor of the vehicle. The method furthermore comprises determining information which relates to a movement of the vehicle. The method furthermore comprises determining a combined image of the camera sensor data and the lidar sensor data based on the information with respect to the movement of the vehicle.

To carry out sensor fusion, it is advantageous if all sensors of the sensor arrangement and also the fusion itself have the same cycle time. For example, a fusion takes place according to a predetermined cycle time which corresponds, for example, to the cycle time of the camera and the cycle time of the radar device. Alternatively, one of the cycle times can also be an integer multiple of the other cycle times, due to which information is provided more frequently by one of the sensors than by another. Otherwise, the information intended for sensor fusion would be provided at different times. In any case, different cycle times can result in losses of the performance of the data fusion.

The cycle time of a radar device is typically predetermined and is, for example, 50 ms. In contrast, a typical cycle time of a camera device or a camera is 66 ms. It is conceivable to increase the cycle time of the radar device to 66 ms. However, this would have the disadvantage that highly-dynamic procedures could not be captured as well. For example, an acceleration and/or an acceleration change can be calculated less reliably. For automated driving functions, in particular for active safety, a difference of 16 ms per cycle is already relevant. For example, a function of an automated emergency braking system (AEBS) already reacts measurably worse with a cycle of 66 ms than with a cycle of 50 ms. Alternatively, it is conceivable to shorten the cycle of the radar device to 33 ms, in order to enable data processing synchronized with the camera after every second cycle of the radar device. However, the time for generating the emission signals and/or for processing reception signals is then shorter, due to which a higher computing power would be necessary, which would be accompanied by an increase in the generation of heat per unit of time due to the accompanying calculations. Such additional heat can be complex to dissipate for technical reasons and is to be avoided. A reduction of emissions signals would have the result that the signal-to-noise ratio would decrease, because of which the range of the radar device could be impaired.

Against the background of this prior art, an object of the present disclosure is to specify a device and a method which are each suitable for enhancing the prior art and at least improving the above-mentioned aspects of the prior art. In particular, it is an object of the disclosure to enable more effective acquisition of data by a radar device of a motor vehicle.

At least this object is achieved by the features disclosed herein.

Accordingly, at least this object is achieved according to one aspect of the disclosure by a method for operating a sensor arrangement of a motor vehicle, wherein the sensor arrangement comprises a radar device and a further sensor device; wherein the method comprises: operating the radar device using a radar cycle and using a set of emission signals within the radar cycle; processing, after passage of a partial cycle of the radar cycle, partial information, wherein the partial information characterizes reception signals according to a subset of the set of emission signals corresponding to the partial cycle; processing, after passage of the radar cycle, cycle information, wherein the cycle information characterizes reception signals according to the set of emission signals; operating the sensor device using a sensor cycle, wherein the radar cycle is shorter than the sensor cycle; outputting, after passage of the partial cycle, a close-range characterization on the basis of the partial information; and outputting, at the end of the sensor cycle and/or a multiple of the sensor cycle, the cycle information.

The disclosure in other words in particular provides a method for capturing and providing cycle time-optimized data in automobile radar sensors. A more effective capture of data by a radar device of a motor vehicle is therefore possible in particular in combination with a further sensor device.

It has been recognized that it is possible to maintain the radar cycle as a standard cycle on the part of the emission signal generation. The range of the radar device and also the heat dissipation can therefore be fundamentally ensured and an impairment can be avoided. For this purpose, it is proposed that, for example, for the closer range having little distance from the radar device, the processing for detection formation can already be started after the partial cycle on the basis of the subset of the emitted emission signals of the emission signals emitted within the radar cycle and correspondingly received reception signals. The reception signals of the partial cycle do have less information than the reception signals of the radar cycle, but are sufficient for, for example, close-range detection and enable rapid and efficient numeric processing without excess production of heat. Possible disadvantages, for example, with respect to the sensitivity in the processing of the partial information can be accepted, since the partial cycle primarily relates to close-range coverage. After the complete reception signals of the radar cycle are present, the reception signals are conventionally processed in order to calculate the cycle information. Therefore, a later, middle detection time is present, which can help thanks to the intermediate step via the evaluation of the partial information, for example, to detect relative velocity changes faster.

Providing the cycle information can be delayed, due to which optional further processing steps are possible in order to improve the quality of the information. The cycle information is only made available after passage of the sensor cycle. The cycle information and the sensor data can therefore be provided synchronously. Optionally, the cycle information can be provided with a timestamp in order to be able to take into consideration possible waiting between an end of the processing of the cycle information and an end of the sensor cycle.

The partial cycle is optionally a unit fraction of the sensor cycle. It can therefore be ensured that an integer multiple of the partial cycle corresponds to a sensor cycle. A plurality of partial cycles corresponding to the multiple can therefore be implemented within one sensor cycle. Alternatively or additionally, the partial cycle is half as long as the sensor cycle. The unit fraction is therefore, for example, one half. In other words, two partial cycles can be implemented within the sensor cycle.

The method optionally comprises: repeating the steps of the method after passage of a multiple of the partial cycle. It is therefore possible to repeat the method including possible intermediate steps. It has been recognized that this can be achieved in particular by a suitable division of the radar cycle into partial cycles.

The method optionally comprises: operating the radar device using an auxiliary cycle and using a set of auxiliary emission signals within the auxiliary cycle, wherein the auxiliary cycle has a duration corresponding to the radar cycle; processing, after passage of the auxiliary cycle, auxiliary information, wherein the auxiliary information characterizes reception signals according to a set of auxiliary emission signals emitted within the auxiliary cycle; and the auxiliary cycle begins before the end of the sensor cycle and after the radar cycle. It has been recognized that a discrepancy between the sensor cycle and the radar cycle can enable an auxiliary cycle shortened in relation to the radar cycle to be used. The auxiliary cycle can correspond in length to a partial cycle here, due to which a subset of emission signals is accordingly emitted as auxiliary emission signals within the auxiliary cycle and a corresponding set of reception signals is received. Such a pseudo-cycle or auxiliary cycle can improve, for example, the tracking of objects and/or can be used to improve the quality of an estimation of the acceleration. It is therefore in particular possible if needed to deal better with dynamic scenarios.

The method optionally comprises: performing data fusion on the basis of the cycle information and sensor data captured by the sensor device. It has been recognized that synchronous provision of the cycle information with sensor data enables reliable data fusion matched to the sensor cycle.

Optionally, processing of the cycle information and the partial information alternating with respect to target features takes place between a plurality of sensor cycles. In each second complete radar cycle, all emission signals are processed, but alternately with additional time for the calculation of various target features, for example alternately between a set of features for a high-resolution detection and a set of features for a minimum scope of detections.

According to at least one aspect of the disclosure, a computer program and/or a computer-readable medium is/are provided. The computer program and/or the computer-readable medium comprise(s) instructions which, when the program or the instructions is/are executed by a data processing device, cause the latter to carry out the method according to the disclosure and/or steps thereof. Optionally, the computer program and/or the computer-readable medium comprise(s) instructions which, when the program or the instructions is/are executed by a data processing device, cause the latter to carry out the method steps described as advantageous or optional in order to achieve an associated technical effect.

According to at least one aspect of the disclosure, a data processing device for a motor vehicle is provided. The data processing device is configured to carry out the method according to the disclosure. Optionally, the data processing device is configured to carry out a method step described as advantageous or optional and/or to implement a method feature in order to achieve an associated technical effect.

According to at least one aspect of the disclosure, a motor vehicle is provided, comprising the data processing device according to the disclosure and a sensor arrangement comprising a radar device and a further sensor device. Optionally, the data processing device of the motor vehicle and/or the motor vehicle is/are configured to carry out a method step described as advantageous or optional and/or to implement a method feature in order to achieve an associated technical effect.

Optionally, the sensor device comprises a camera and the sensor cycle is 66 ms. The sensor device can comprise further sensors alternatively or additionally to the camera, which are to be evaluated with the information of the radar device. Moreover, the sensor cycle can also have a duration differing from 66 ms, also in the case of a camera.

At least one embodiment is described below with reference to the figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a motor vehicle according to one aspect of the disclosure;

FIG. 2 schematically shows a flow chart of a method according to one aspect of the disclosure;

FIG. 3 shows a schematic representation of a computer program and/or computer-readable medium according to one aspect of the disclosure;

FIG. 4 shows operation of a radar device according to the prior art; and

FIG. 5 shows operation of a radar device according to a method according to one aspect of the disclosure.

### DETAILED DESCRIPTION OF THE DRAWINGS

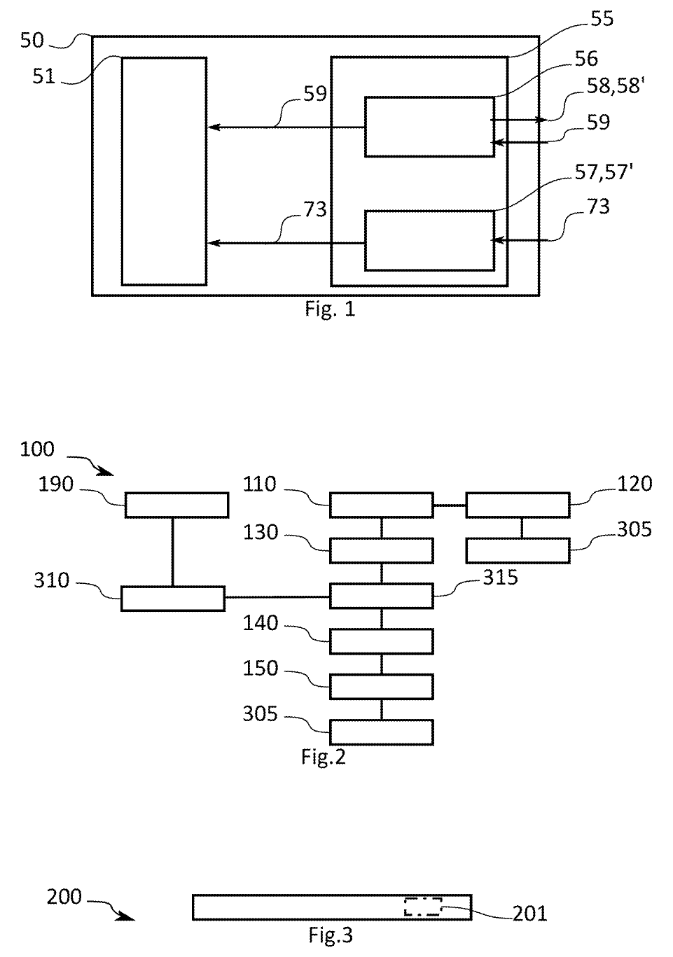

FIG. 1 schematically shows a motor vehicle 50 according to one aspect of the disclosure. The motor vehicle 50 is a land vehicle. The motor vehicle 50 is a passenger vehicle.

The motor vehicle 50 comprises a data processing device 51. The motor vehicle or the data processing device 51 is configured to carry out the method 100 described with reference to FIG. 2. For this purpose, the motor vehicle 50 according to FIG. 1 has a sensor arrangement 55.

The sensor arrangement 55 comprises a radar device 56 and a further sensor device 57. In another embodiment (not shown), the sensor arrangement 55 can comprise further devices. The sensor device 57 according to FIG. 1 is, for example, a camera 57'. In another embodiment (not shown), the sensor device 57 can comprise a device 57 different from a camera 57'.

The sensor arrangement 55 is configured to acquire information relating to the surroundings of the motor vehicle 50. The components of the sensor arrangement 55, thus the radar device 56 and the further sensor device 57, are each characterized by a cycle time. Within the respective cycle time, the respective component of the sensor arrangement 55 acquires and processes information and provides it to the data processing device 51. The data processing device 51 has a communication connection to the sensor arrangement 55 in order to retrieve the provided information and in particular process it by data fusion or sensor fusion. Moreover, the data processing device 51 can be configured to control the sensor arrangement 55 for the operation of the sensor arrangement 55.

FIG. 2 schematically shows a flow chart of a method 100 according to one aspect of the disclosure. The method 100 according to FIG. 2 is a method 100 for operating a sensor arrangement 55 of a motor vehicle 50, wherein the sensor arrangement 55 comprises a radar device 56 and a further sensor device 57. Such a motor vehicle 50 is described with reference to FIG. 1. FIG. 2 is described with reference to FIG. 1.

The method 100 according to FIG. 2 comprises: Operating 110 the radar device 56 using a radar cycle 60 and using a set of emission signals 58 within the radar cycle 60. In accordance with the set of emission signals 58, the radar device 56 receives reception signals 58 within the radar cycle 60 and processes them or forwards them for processing to a data processing device 51.

The method 100 comprises: Processing 130, after passage of the radar cycle 60, cycle information 71, wherein the cycle information 71 characterizes reception signals 59 according to the set of emission signals 58. After passage of the radar cycle 60, the radar device 56 therefore provides comprehensive information which enables a comprehensive characterization of the surroundings by way of distance data, even at long distance.

The method 100 comprises: Processing 120, after passage of a partial cycle 62 of the radar cycle 60, partial information 70, wherein the partial information 70 characterizes reception signals 59 according to a subset of the set of emission signals 58 corresponding to the partial cycle 62. The partial information 70 is already processed before passage of the radar cycle 60. The partial information 70 is based on the subset of emission signals 58. Therefore, the partial information 70 related to the partial cycle 62 comprises an information content reduced in relation to the radar cycle 60.

The method 100 comprises: Outputting 305, after passage of the partial cycle 62, a close-range characterization on the basis of the partial information 70. The subset of the set of emission signals 58 can be sufficient in this case to be able to carry out a characterization of the close range of the motor vehicle 50. The partial cycle 62 is a unit fraction of the sensor cycle 64. For example, the partial cycle 62 is half as long as the sensor cycle 64 (see FIG. 5). In another embodiment (not shown), the partial cycle 62 can also be another unit fraction of the sensor cycle 64, for example the partial cycle 62 can be a third as long as the sensor cycle 64, a fourth as long as the sensor cycle 64, etc.

Processing 120 the partial information 70 and outputting 305 the partial information 70 take place before passage of the radar cycle 60 and therefore parallel to further steps of the radar cycle 60. In particular, the processing of the partial information 70 can be carried out while the radar device 56 emits a remaining set of the emission signals 58 after the emission of the subset of the set of emission signals 58.

The method 100 comprises: Operating 190 the sensor device 57 using a sensor cycle 64, wherein the radar cycle 60 is shorter than the sensor cycle 64. The operation of the sensor device 57 thus takes place in parallel to the operation of the radar device 56. The sensor device 57 provides comprehensive information after passage of the sensor cycle 64, which enables a comprehensive characterization of the surroundings, for example by way of image data.

The method 100 comprises: Outputting 310, at the end of the sensor cycle 64 and/or a multiple of the sensor cycle 64, the cycle information 71. After the passage of the radar cycle 60, a waiting time or holding time is thus provided until the end of the sensor cycle 64. In this way, the cycle information 61 is provided synchronously with the sensor data 73.

The method 100 comprises: Performing 315 data fusion on the basis of the cycle information 71 and sensor data 73 acquired by the sensor device 57. The fact is utilized here that the cycle information 71 and the sensor data 73 are provided comprehensively and synchronously to be able to carry out the data fusion. Optionally, the cycle information 71 can be provided with a timestamp which indicates the end of the radar cycle 60.

The method 100 comprises: Operating 140 the radar device 56 using an auxiliary cycle 66 and using a set of auxiliary emission signals 58' within the auxiliary cycle 66, wherein the auxiliary cycle 66 has a duration corresponding to the partial cycle 62.

The method 100 comprises: Processing 150, after passage of the auxiliary cycle 66, auxiliary information 72, wherein the auxiliary information 72 characterizes reception signals 59 according to a set of auxiliary emission signals 58' emitted within the auxiliary cycle 66. The duration of the auxiliary cycle 66 corresponding to the radar cycle 66 enables processing of the auxiliary information 72 equivalent to the partial information 70 and the cycle information 71.

The auxiliary cycle 66 begins before an end of the sensor cycle 64 and after the radar cycle 60. The auxiliary emission signals 58' correspond to the emission signals 58, wherein the emission of the auxiliary emission signals 58' is begun after passage of the radar cycle 60 and before passage of the sensor cycle 64.

The method 100 comprises: Repeating the steps of the method 100 after passage of a multiple of the partial cycle 62. All of the mentioned steps can be periodically repeated in this case.

Processing of the cycle information 71 and the partial information 70 which alternates with respect to target features takes place between a plurality of sensor cycles 64.

In this case, a person skilled in the art recognizes that the method 100 according to FIG. 2 can also be carried out in a sequence other than that shown. In particular, it is possible for steps of the method 100 to be able to be swapped, shifted, repeated, and/or carried out simultaneously.

FIG. 3 shows a schematic representation of a computer program and/or computer-readable medium 200 according to one aspect of the disclosure. The computer program and/or computer-readable medium 200 comprise(s) instructions 201 which, when the program or the instructions 201 is/are executed by a data processing device 51, cause the latter to carry out the method 100 and/or the steps of the method 100 according to FIG. 2.

The instructions 201 can be present as a program code in any code or in any language, in particular in a code suitable for controlling and/or monitoring motor vehicles 50 and/or their sensor arrangements 55. The computer program and/or computer-readable medium 200 may be or comprise any digital data storage device, such as a USB stick, a hard disk, a CD-ROM, an SD card, or an SSD card. The computer program does not necessarily have to be stored on such a computer-readable storage medium, but may also be retrieved via the Internet or otherwise.

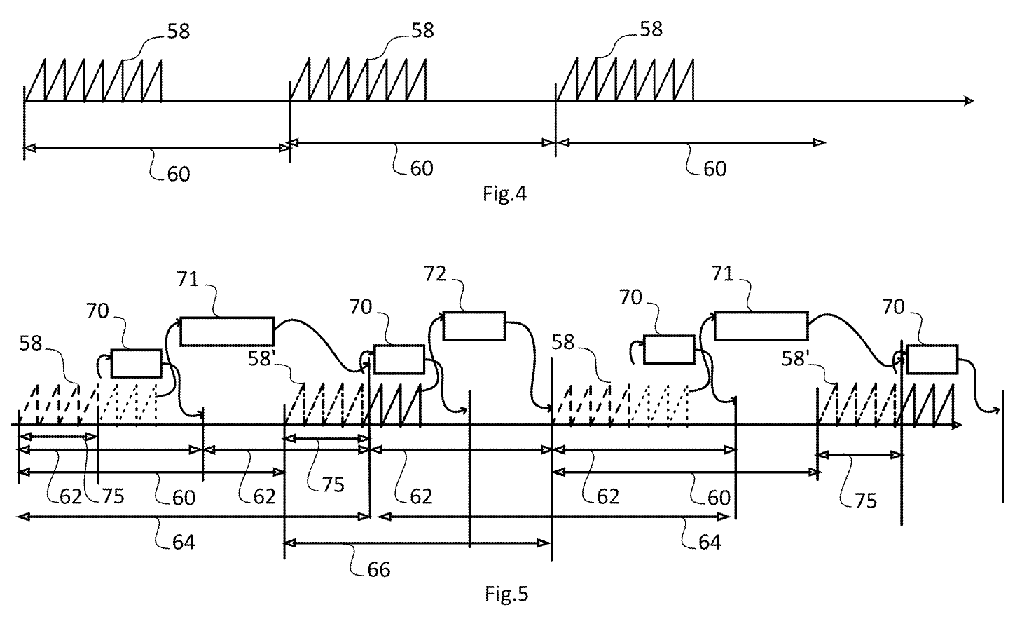

FIG. 4 shows operation of a radar device 56 according to the prior art. The radar device 58 is operated using a radar cycle 60. Within the radar cycle 60, emission signals 58 are emitted, reception signals are received (not shown in FIG. 4), and the reception signals or cycle information 71 based thereon are processed.

FIG. 5 shows operation of a radar device 56 according to a method 100 according to one aspect of the disclosure. Such a radar device 56 is described with reference to FIG. 1. Such a method 100 is described with reference to FIG. 2. FIG. 5 is described with reference to FIGS. 1-3.

According to FIG. 5, a radar cycle 60, a sensor cycle 64, and a partial cycle 62 begin at a starting time (not indicated). The partial cycle 62 is shorter than the radar cycle 60 and the radar cycle 60 is shorter than the sensor cycle 64.

An emission signal 58 having a dashed line illustrates the emission within a partial cycle emission duration 75. After passage of the partial cycle emission duration 75, a reception signal 58 based thereon can already be processed and provided as partial information 70 after passage of the partial cycle 62.

During the processing of the reception signals 59 to determine the partial information 70, further emission signals 58 are emitted, as illustrated by a dotted line. After the emission of the emission signals 58 of the radar cycle 60, the reception signals 59 based thereon are processed. However, the cycle information 71 based thereon is not provided with passage of the radar cycle 60, rather only with passage of the sensor cycle 64.

After passage of the radar cycle 60, an auxiliary cycle 66 begins. At the beginning of the auxiliary cycle 66, auxiliary emission signals 58' are emitted. Further partial information 70 is processed here based on received reception signals 59 of the auxiliary emission signals 58' after passage of a further partial cycle emission duration 75. After passage of the auxiliary cycle 66, auxiliary information 72 is determined, wherein the auxiliary information 72 characterizes reception signals 59 according to a set of auxiliary emission signals 58' emitted within the auxiliary cycle 66. The auxiliary information 72 can be processed and evaluated before the passage of the second sensor cycle 64.

A radar cycle 60 again follows the auxiliary cycle 66. The partial information 70 is provided here at the end of the sensor cycle 64.

The steps of the method 100 are repeated.

In a specific embodiment and in other words, the method 100 can be summarized with reference to FIG. 5 as follows: A radar cycle 60 of 49.5 ms is maintained as the standard cycle on the part of the radar device 60. For the closer range at short distance to the radar device 60, the processing for detection formation is now already begun after a part of the emitted/received chirps, thus after passage of the partial cycle emission duration 75. For example, the emission signals 58 comprise 256 chirps and a partial cycle 62 relates to 128 of 256 chirps. After the complete 256 chirps are present, they are all processed after passage of the radar cycle 60. The passage of the sensor cycle 64 is waited out for the provision of these data. For this purpose, the partial information 70, which improves the quality, can be provided in the intermediate time. The cycle information 71 is only provided after passage of 66 ms as the sensor cycle 64, optionally with specification of precise acquisition timestamps for compensation in the further processing. A new radar cycle 60 is already started at the end of the second sensor cycle 64, thus at 99 ms. This scheme is repeated. During each second complete 256 chirp range, all chirps are processed, but alternately. In addition, deviating from the 33 ms update, every 99 ms, beginning at 83 ms, an additional "128" detection list can be generated as auxiliary information 72 in order to be able to deal even better with dynamic scenarios if needed. A center point of all ramps of the emission signals 58 is always transmitted.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

50 motor vehicle
51 data processing device
55 sensor arrangement
56 radar device
57 sensor device
57’ camera
58 emission signals
58' auxiliary emission signal
59 reception signal
60 radar cycle
62 partial cycle
64 sensor cycle
66 auxiliary cycle
70 partial information
71 cycle information
72 auxiliary information
73 sensor data
75 partial cycle emission duration
100 method
110 operating a radar device using a radar cycle
120 processing partial information
130 processing cycle information
140 operating a radar device using an auxiliary cycle
150 processing auxiliary information
190 operating a sensor device
305 outputting a close-range characterization
310 outputting cycle information
315 performing a data fusion
200 computer program and/or computer-readable medium
201 instructions

What is claimed is:

1. A method for operating a sensor arrangement of a motor vehicle, wherein the sensor arrangement comprises a radar device and a further sensor device, the method comprising:
operating the radar device using a radar cycle and using a set of emission signals within the radar cycle;
processing, after passage of a partial cycle of the radar cycle, partial information that characterizes reception signals according to a subset of the set of emission signals corresponding to the partial cycle;
processing, after passage of the radar cycle, cycle information characterizing reception signals according to the set of emission signals;
operating the sensor device using a sensor cycle, wherein the radar cycle is shorter than the sensor cycle;
outputting, after passage of the partial cycle, a close-range characterization on the basis of the partial information; and
outputting, at the end of the sensor cycle and/or a multiple of the sensor cycle, the cycle information.

2. The method of claim 1, wherein the partial cycle is a unit fraction of the sensor cycle and/or the partial cycle is half as long as the sensor cycle.

3. The method of claim 1, further comprising: repeating the steps of the method after passage of a multiple of the partial cycle.

4. The method of claim 1, wherein the method further comprises:
operating the radar device using an auxiliary cycle and using a set of auxiliary emission signals within the auxiliary cycle, wherein the auxiliary cycle has a duration corresponding to the radar cycle; and
processing, after passage of the auxiliary cycle, auxiliary information characterizing reception signals according to a set of auxiliary emission signals emitted within the auxiliary cycle,
wherein the auxiliary cycle begins before an end of the sensor cycle and after the radar cycle.

5. The method of claim 1, further comprising:
performing a data fusion based on the cycle information and sensor data acquired by the sensor device.

6. The method of claim 1, wherein processing the cycle information alternating with respect to target features takes place between a plurality of radar cycles.

7. A non-transitory computer-readable medium comprising instructions that, when executed by a data processing device, cause the device to carry out the method of claim 1.

8. A data processing device for a motor vehicle, comprising:
a data processing device configured to carry out the method of claim 1.

9. A motor vehicle, comprising:
the data processing device of claim 8; and
a sensor arrangement comprising: a radar device and a further sensor device.

10. The motor vehicle of claim 9,
wherein the sensor device comprises a camera, and
wherein the sensor cycle is 66 ms.
